(19) United States
(12) Patent Application Publication
(10) Pub. No.: US 2018/0180267 A1
(43) Pub. Date: Jun. 28, 2018

(54) Mobile Lighting System

(71) Applicant: Stingray Industries, LLC, Fort Smith, AR (US)

(72) Inventors: David Theodoro, St. Louis, MO (US); Nick Theodoro, Fort Smith, AR (US)

(73) Assignee: Stingray Industries, LLC, Fort Smith, AR (US)

(21) Appl. No.: 15/854,427

(22) Filed: Dec. 26, 2017

Related U.S. Application Data
(60) Provisional application No. 62/438,560, filed on Dec. 23, 2016.

(51) Int. Cl. F21V 21/14; F21L 14/04; B60Q 1/24; F21V 21/36; F21V 21/30

(52) U.S. Cl. CPC F21V 21/145; F21L 14/04; F21V 21/22; F21V 21/36; F21V 21/30; B60Q 1/245

(57) ABSTRACT

A mobile lighting system configured to provide lighting to remote locations. The system is configured to be moved into a location by rolling on a moving apparatus, such as wheels or a continuous track and to shine light on a desired area by adjusting poles to raise or lower the nights, and rotating the lights within a mount that is mounted to the pole. The mobile lighting system has a power source, such as a battery, to provide several hours of lighting at a remote location.

### RELATED APPLICATION

This application claims priority to U.S. Provisional Patent Application No. 62/438,560, filed Dec. 23, 2016, which is incorporated herein in its entirety by this reference.

### FIELD OF THE INVENTION

The present invention relates to a method and device for providing remote mobile lighting, and more specifically to a mobile lighting method, device, and system capable of providing bright and adjustable lighting to a remote location.

### BACKGROUND

Mobile lighting is well-known in many industries and includes many products such as flashlights and cellular phones. In one particular industry, mobile lighting is used to illuminate a road construction work area allowing workers to work at night. These lights are typically very large and require a vehicle to move them into the desired location. Further, mobile construction lighting systems are used to light very large areas, and these lights generally require a gasoline generator to power them. Due to the power requirements and the non-remote locations of most construction work, battery power is not common in construction lighting.

Mobile lighting systems also exist for home and garage use. These units are lighter than the construction units. Mobile lighting units built for home use are typically lightweight enough that a person can easily carry the light around the house. Further, home units typically have insufficient battery storage and/or power to provide many hours of bright illumination. Such a battery would be impractical for home lighting units because of easy access to a wall outlet for charging or an extension cord to provide electricity as needed.

Some lighting systems exist for outdoor and camping purposes, however these lights cannot provide many hours of very bright light. In addition, outdoor lighting units are often made of plastic or other less durable materials. Still further, these lighting units are typically not adjustable.

Therefore there is a need for an improved mobile lighting unit which overcomes these and other disadvantages in the prior art.

### SUMMARY

An aspect of the present disclosure is generally directed toward a mobile lighting system which may include wheels, tires, axles, a frame, fixed or telescoping poles, a power source, storage containers, a handle, and lights. The system may include a box for the power supply and one or more other boxes for storage. Additional boxes may be added, and these additional boxes may be customizable as to the needs of the user.

Another aspect of the present disclosure is that the lighting system may also have interchangeable lights that may come in a variety of shapes, sizes, and colors. The power source may include batteries and/or the ability to plug the system into a constant energy source such as a wall outlet, an external battery, or a gas generator. The system may also be capable of charging slowly while the system is in use and plugged into a constant energy source. In addition, the lighting system may include a more powerful and higher capacity battery than existing systems. The battery system may be capable of providing hours of bright lighting without the need to be charged. The mobile lighting system may use high efficiency bulbs, such as LEDs, to increase battery life and the lit usage time between charges.

Yet another aspect of the present disclosure is generally directed to methods and components for moving and transporting the lighting system. The system may include wheels allowing users to easily move the system to where light is needed. The system may be moved by hand or with a vehicle. In addition to being independently mobile, the system may be transportable, such that the lighting system can be collapsed and stored in a vehicle to transport the mobile lighting system over longer distances.

Another aspect of the present disclosure is that the mobile lighting system may use more durable materials than existing systems, such as aluminum and steel. These materials provide specific advantages for use of the mobile lighting system in hunting. More durable materials can support more weight, allowing a mobile lighting system to be used in more rugged environments and allow the system to support heavy loads for use as a dolly to transport equipment and animal parts.

Yet another aspect of the disclosure is that the mobile lighting system may have telescoping poles that connect the lights to the frame of the lighting system. Moving the telescoping poles from a first position to a second position allows adjustment of the lights relative to the frame. In addition, the lights may be connected to the telescoping poles with adjustable mounts that allow the lights to be rotated 360 degrees in any axis using a ball type rotating joint. In conjunction, the telescoping poles, rotating mounts, and mobility of the lighting system allow a user to adjust and focus the light on the exact areas where light is needed.

Another aspect of the invention relates to a method of using a lighting system to light an area, wherein the lighting system has a frame combined with wheels or another suitable moving apparatus, a body section extending away from the base section when the lighting system is in an upright position, at least one storage compartment connected to the frame having a power source, and power cable between the power source and at least one light attached to the frame. A user may charge the power source or connect a new battery before using the system. Then, the system may be moved to a desired location, which may be a remote location in a field or forest away from vehicles and buildings. In one specific example, the system may be moved to a location where a user is hunting, camping, or fishing. The user may then move a switch to an “on” position to power the light and illuminate an area. The user may adjust the light upward or downward by adjusting the telescoping poles relative to the frame and the user may rotate the light around a vertical axis of rotation to focus the light on a specific area.

### BRIEF DESCRIPTION OF THE FIGURES

FIG. 1 is a perspective view of the front side of an embodiment of the mobile lighting system.

FIG. 2 is a perspective view of the back side of an embodiment of the mobile lighting system.

FIG. 3 is a perspective view of a second embodiment of the frame of the mobile lighting system showing the power cable coiled around the poles.

FIG. 4 is a side perspective view of an embodiment of the frame of the mobile lighting system.

FIG. 5 is a close-up perspective view of the lights and power cable of the mobile lighting system.

FIG. 6 is a perspective view of the front side of an embodiment of the mobile lighting system.

### DETAILED DESCRIPTION

Before the present disclosure is described further, it is to be understood that the present disclosure is not limited to the particular embodiments of the invention described below as variations of the particular embodiments may be made and still fall within the scope of the appended claims. It is also to be understood that the terminology employed is for the purpose of describing particular embodiments/aspects, and is not intended to be limiting.

In this specification and the appended claims, the singular forms “a,” “an” and “the” Include plural reference unless the context dearly dictates otherwise.

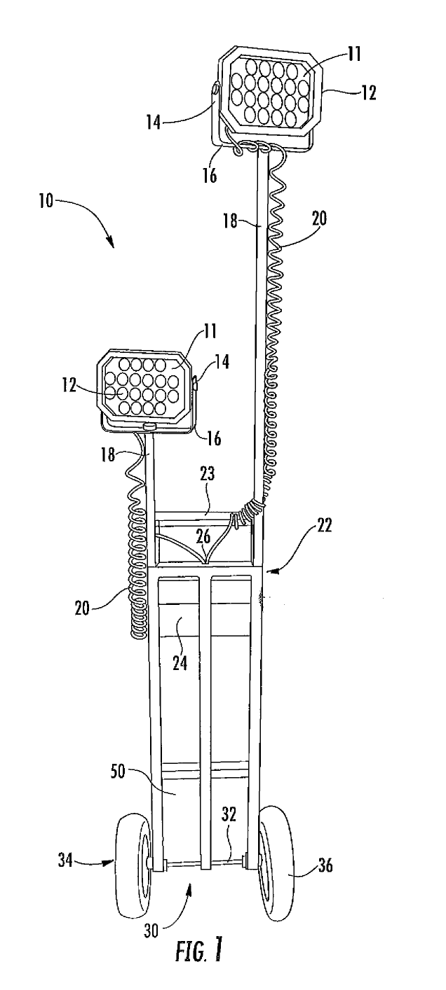

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

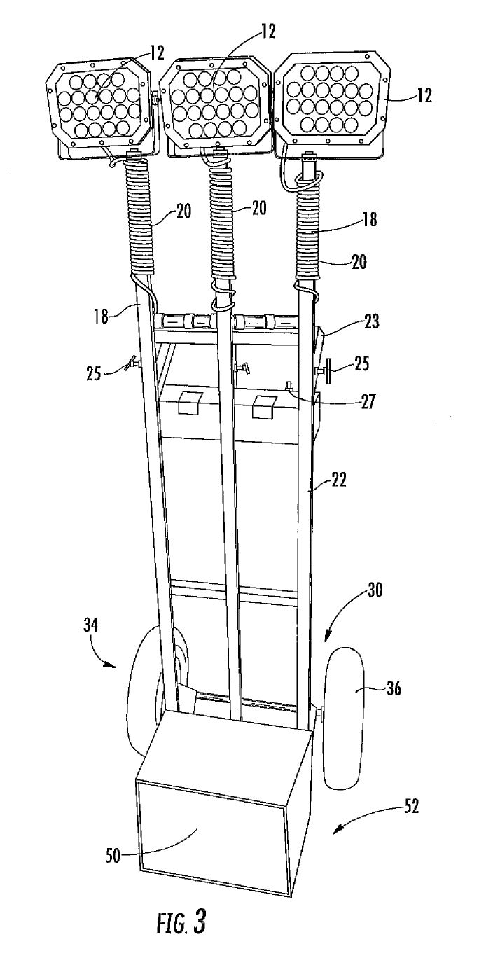

Referring to FIG. 1, reference numeral 10 generally designates a mobile lighting system 10. A frame 22 may connect the parts of the mobile lighting system 10. Frame 22 connects to handle 23, support members 18, storage container 24, power cable(s) 20, moving apparatus 30, and base section 52 (shown in FIG. 3).

The frame 22 may be constructed of a substantially rigid material, such as aluminum or steel. Plastic materials, carbon fiber, or any combination thereof may be used as well. The frame 22 may have combined sections to create a frame capable of withstanding substantial loads, such as a downward load of more than one thousand pounds. In one embodiment, the frame 22 may be constructed of two members placed generally vertically and generally in parallel between one and three feet apart. A third member may be combined generally perpendicular to the two parallel members at one end of the two members by welding or any other suitable means. The members may be made from aluminum, metal, plastic or any other suitable material, such as carbon fiber or any combination thereof. The three members may have a rectangular, square, or circular cross section and may be hollow. At the other end of the two parallel members, a hollow member with a circular cross section may be combined perpendicular to the two parallel members. The member with a circular cross section may serve as housing for an axle 32 of the moving apparatus 30. As shown in FIG. 1, a reinforcement bar or bars may be combined between the perpendicular and parallel members to provide additional support. In one embodiment, support members may be combined perpendicular to the parallel members at the centerline of the parallel members and another support member may be combined parallel to the parallel members half way between the parallel members.

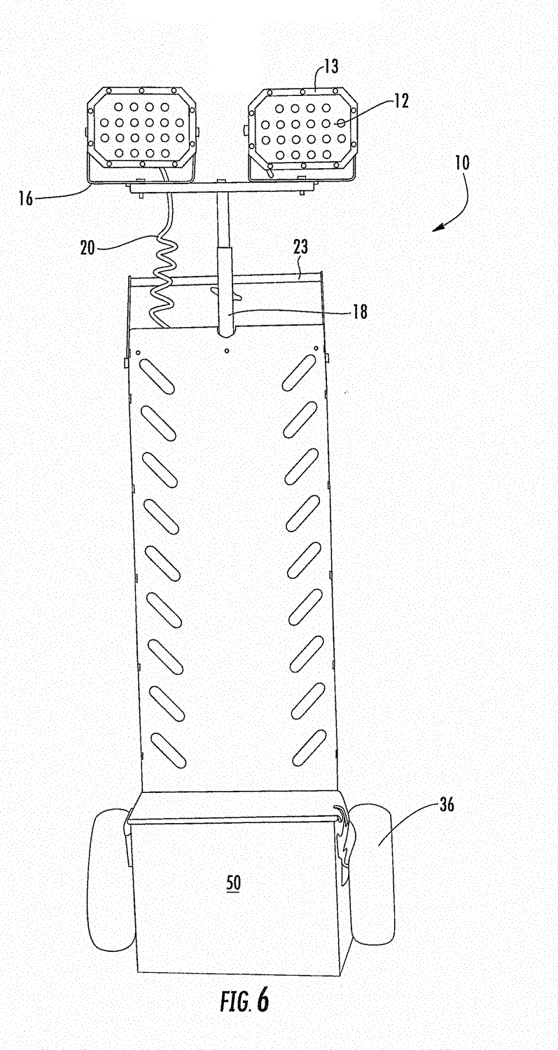

In an alternate embodiment shown in FIG. 6, the frame 22 may be a solid member comprising a generally vertical support which may be a continuous sheet of metal or plastic instead of the separate spaced apart support members 18. In a similar embodiment, a solid member may extend across and cover the spaced apart support member 18.

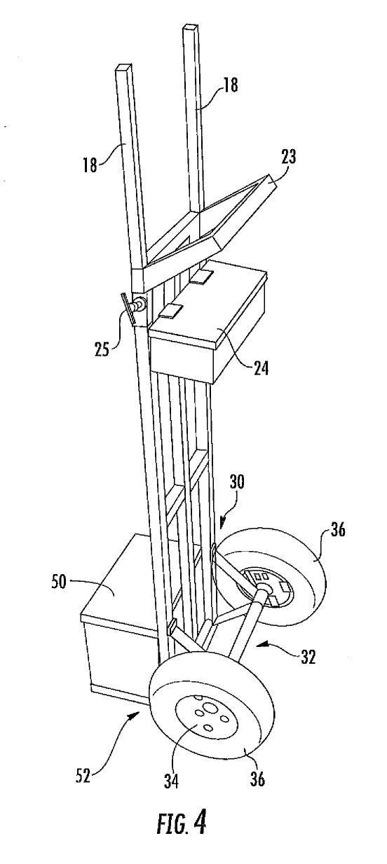

In another embodiment, shown in FIG. 4, the axle 32 may be located in a different plane than the frame 22 and combined to the frame 22 with four support members. The four support members may be solid and of the same material as the frame. The four members may connect at one end to the frame at substantially a 45 degree angle and connect at the other end to the axle housing. Two support members may connect at a top part of the axle housing and the other two members may connect at a bottom part of the axle housing. Other embodiments, such as an axle system without housing, are also possible.

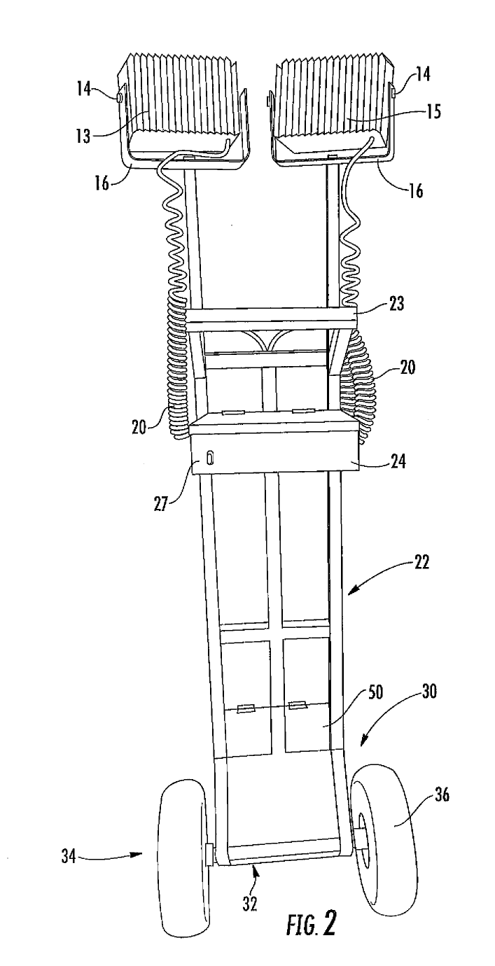

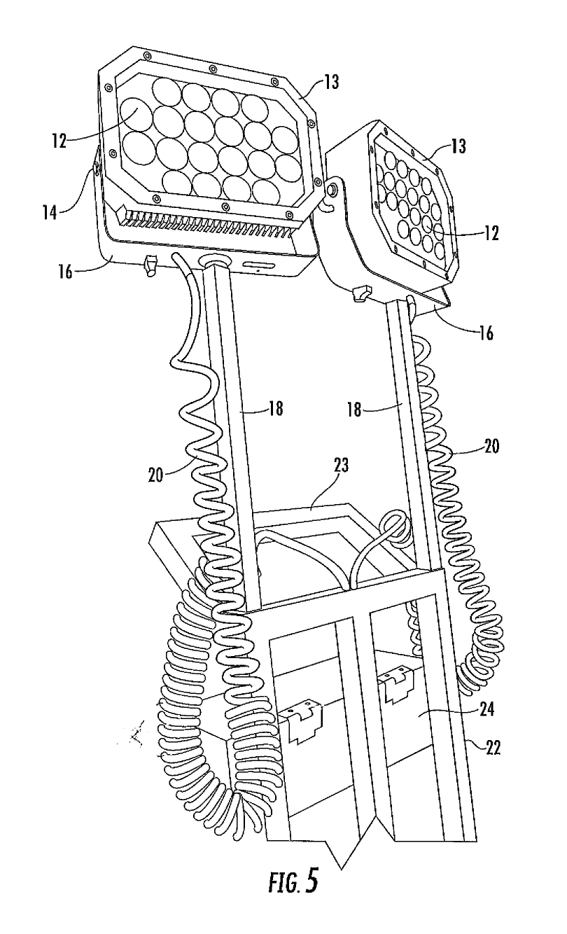

The system includes several features for adjusting the position of the light 12 relative to the frame 22. If multiple lights 12 are used, each light 12 may be adjusted independently. As shown in FIG. 1, light(s) 12, may connect to support members 18 such as rods or poles using mount(s) 16. FIG. 5 is a close-up view of light(s) 12, support members 18 and mount(s) 16. Support members 18 may be combined to frame 22 by welding or connected by any other method known in the art. Support members 18 may also have a telescoping function wherein support members 18 may slide in and out of frame 22 to provide a height adjustment and lock into place at any length along the length of the support members 18. Lock(s) 25 may be hand clamp type locks as shown in FIGS. 3 and 4 or any other lock that is known in the art. Support members 18 may be connected to mount(s) 16 at an end by a threaded, combined, or other connection known in the art. The connection between the support member 18 and the mount(s) 16 may be a pivotal connection thereby allowing the mount(s) 16/light 12 to be pivoted around a vertical axis to further adjust the area of illumination. Mount(s) 16 may be made of metal or another substantially rigid material and may be pivotally combined with support members 18 to be rotatable 360 degrees in multiple planes. Mount(s) 16 may have connection 14 to attach mount(s) to light case 13. Connection 14 may be a screw type connection that allows light case 13 to pivot upward and downward around a horizontal axis to further adjust the area of illumination. In other embodiments the mount(s) 16 may connect to the top and/or bottom of the light case 13 thereby allowing pivotal adjustment of the light relative to the mount(s) 16 around a vertical axis instead of a horizontal axis. Light case 13 may be made of plastic or other material known in the art and may be water resistant or water proof. Light(s) 12 may be encased inside of light case 13 and may have reflective backing 11. FIG. 2 shows a back side of mobile lighting system 10 with power cable(s) 20 displayed. Power cable(s) 20 may have a first part that is coiled and a second part that runs through frame 22 to base section 30, eventually mating with power source 50 (FIG. 3). The coiled portion is flexible and expandable thereby allowing the power cable 20 to move from a first length to a second length as the support member(s) 18 is raised and lowered relative to the frame 22. A handle 23 may be mounted to the frame between two feet and five feet above the base section 52.

Frame 22 is also connected to base section 52, which may contain the moving apparatus 30 and power source 50, which may be a battery. The base section 52 may have a surface which extends outward from the bottom of the frame 22 at generally a right angle so that the frame 22 and base section 52 generally form an “L” shape. In this configuration, the base section 52 contacts the underlying ground surface to help support the frame 22 in an upright position. The moving apparatus may be comprised of at least one wheel 34 connected to an axle 32 which may connect to bottom section 52 of frame 22. An end bolt may be used to fix wheel 34 to axle 32. The moving apparatus may further be comprised of tire(s) 36 that matingly engage with wheel(s) 34. The moving apparatus may use other systems known in the art, such as a continuous track or other systems known in the art. In addition, power source 50 is not limited to batteries and may also use any system known in the art.

The mobile lighting system 10 may be moved by grasping the handle 23 and pulling or pushing the system on the wheels 34 or track. This movement is similar to that of a conventional hand-truck or dolly. Users may move the mobile lighting system 10 into a position to provide lighting where it is desired. The light(s) 12 may be adjusted to sit at a specific height using the support members 18, and then rotated on mount(s) 16 to shine light at a desired location. Power cable(s) 20 may stretch or uncoil to elongate along with support members 18. In an embodiment with multiple lights, each light 12 can be shined in different directions if so desired.

The light(s) 12 may be powered by a power source 50, such as a battery. The power source does not need to be in base section 52 and may be located in storage container 24 or any other location along the length of the frame 22. The base section 52 and the storage container 24 are both enclosures having sidewalls, a bottom, and a top to help protect the contents inside. One of the sidewalls, bottom, or top is movable thereby allowing access to the inside, e.g. to allow access to the battery housed inside the compartment. In some embodiments, the light(s) 12 may be powered by a constant energy source, such as a home power outlet or generator. Power may run from the power source 50, into the power cable(s) 20 to the light(s) 12. As shown in FIG. 2, a switch may be used to turn the light(s) on and off by opening and closing a circuit to selectively allow or prevent power from reaching the light(s) 12.

In use, a user may charge the power source or connect a new battery before using the system. Then, the system may be moved to a desired location, which may be a remote location in a field or forest away from vehicles and houses. In one specific example, the system may be moved to a location where a user is hunting, camping or fishing. The user may then move a switch to an “on” position to activate the light 12 to illuminate an area. The user may adjust the light 12 using one or more of several adjustment features to direct and focus the light on a specific area. First, the user may adjust the height of the light 12 upward or downward by moving the support member 18 relative to the frame 22. The user may also pivot the light 12 along a vertical axis as the mount 16 pivots relative to the support member 18. The user may also pivot the light 12 relative to the mount 16. Depending on the connection between the mount 16 and the light 12, this may be a horizontal pivot axis moving the light upward and downward or it may be a vertical pivot axis moving the light left and right.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within the described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A system comprising:
a light mounted to a frame, the frame comprising a base section having a moving apparatus and a support member connected to the light;
a body section of the frame extending up from the base section when the system is in an upright position, the body section having at least one connection mounted to at least one location along a length of the body section;
at least one storage container attached to the at least one connection, wherein the at least one storage container houses a power source;
a power switch;
a handle; and
a power cable between the power source and at least one light, wherein the power cable is coiled and expandable.

2. The lighting system of claim 1, further comprising a movable mount having a first portion combined with the light and a second portion combined with the support member, wherein the moveable mount is rotatable relative to the frame.

3. The lighting system of claim 2, wherein the light is pivotally combined with the movable mount.

4. The system of claim 1, wherein the support member is a telescoping pole movable relative to the frame from a first position to a second position.

5. The system of claim 4, wherein the telescoping pole is secured in the second position by hand clamp locks.

6. The system of claim 1, wherein the moving apparatus comprises an axle connected to the frame with a first wheel at a first end of the axle and a second wheel at a second end of the axle, the first and second wheel attached to the axle with at least one bolt and the first and second wheels being matingly engaged to a tire.

7. The system of claim 1, wherein the power switch is mounted to the storage container or the frame.

8. The system of claim 1, wherein the light is connected to the support member with a moveable mount, the moveable mount allowing for 360 degree rotation of the light.

9. The system of claim 8, wherein the moveable mount is a ball type rotating joint.

10. The system of claim 1, wherein the frame comprises a plurality of hollow members having a circular cross section and collapsible joints, wherein the collapsible joints have a locked position and an unlocked position, and wherein the hollow members may fold upon on another when the collapsible joints are in the unlocked position.

11. A lighting system comprising:
at least one light mounted to a frame, the frame comprising a base section having a moving assembly and a body section;
the body section extending away from the base section, the body section having at least one connection mounted to at least one location along a length of the body section;
a telescoping support member attached to the body section having a first end attached to the body section and a second end attached to the light, wherein the telescoping support member is movable relative to the frame between a first position and a second position;
at least one storage container having a power source;
a power switch; and
a power cable between the power source and the at least one light.

12. The lighting system of claim 11, wherein the moving assembly is a wheel and tire system comprising at least one wheel and at least one tire.

13. The lighting system of claim 11, wherein the moving assembly is a continuous track driven by two or more wheels.

14. The lighting system of claim 11, wherein the frame comprises a first member having a first end and a second end and a second member having a first end and a second end, the first member and the second member spaced between one and three feet apart in parallel, a third member attached perpendicularly to the first member and the second member.

15. The lighting system of claim 14, wherein the frame further comprising a fourth member, wherein third member is attached to the first member and the second member at their first ends, and the fourth member is attached to the first member and the second member at their second ends.

16. The lighting system of claim 15, wherein the fourth member has a hollow cross-section and serves as a housing for an axle.

17. The lighting system of claim 16, further comprising a moving apparatus connected to the axle.

18. The lighting system of claim 11, further comprising a movable mount having a first portion combined with the light and a second portion combined with the support member, wherein the moveable mount is rotatable relative to the frame.

19. The lighting system of claim 18 wherein the light is pivotally combined with the movable mount.

20. A lighting system comprising:
at least one light mounted to a frame, the frame comprising a base section having a moving assembly and a body section;
a telescoping support member attached to the body section having a first end attached to the body section and a second end attached to the light, wherein the telescoping support member is movable relative to the frame between a first position and a second position;
at least one storage container having a power source;
a power cable between the power source and the at least one light;
a movable mount having a first portion combined with the light and a second portion combined with the support member, wherein the moveable mount is rotatable relative to the frame, wherein the light is pivotally combined with the movable mount.
